(19) United States
(12) Patent Application Publication
(10) Pub. No.: US 2007/0250894 A1
(43) Pub. Date: Oct. 25, 2007

(54) Digital television system using high-speed serial bus and method for controlling the same

(76) Inventor: Jeongki Kim, Seoul (KR)

Correspondence Address: J.C. Patents, Suite 250, 4 Venture, Irvine, CA, 92618, US

(21) Appl. No.: 11/402,699

(22) Filed: Apr. 11, 2006

(51) Int. Cl. H04N 7/173; H04N 7/16

(52) U.S. Cl. 725/133; 725/100; 725/131; 725/139; 725/151; 725/153

(57) ABSTRACT

A digital TV system using a high-speed serial bus and a method for controlling the same are disclosed. The digital TV system includes a TV receiver and a computer device. The TV receiver includes a tuner unit, a demodulator, and a high-speed serial bus unit for transmitting digital data to the computer device through the high-speed serial bus. The computer device includes a high-speed serial bus driver, a central processing unit (CPU), a digital audio/video (AV) process control unit for being executed by the CPU so as to process the digital data according to a programmed processing means and information data, and a mass storage device for storing the data.

### BACKGROUND OF THE INVENTION

1. Field of the invention

The present invention relates to a digital television (TV) system using a high-speed serial bus and a method for controlling the same, and more particularly, to a digital TV system using a high-speed serial bus and a method for controlling the same, which can process video and audio data of a TV receiver, update and activate diverse functions of the digital TV receiver, and provide channel information having a diagrammed electronic program guide to viewers, using a high-speed serial bus.

2. Description of the Prior Art

A digital TV system has been implemented by diverse appliances such as a digital TV receiver, a TV receiver for a computer, and others. In particular, a conventional TV receiver for a computer mainly uses a data transmission system through a PCI (Peripheral Component Interconnect) bus or an ISA (Industry Standard Architecture) bus, and thus it requires a separate computer card.

In addition, since a conventional digital TV system has no compatibility among its diverse optional functions, an expensive digital TV receiver should be purchased in order to use new optional functions of the TV receiver.

In addition, the conventional digital TV system has used the same channel changing method as an analog TV system that has a relatively small number of channels simply using channel changing buttons of a TV receiver, set top box, or remote controller. Accordingly, in receiving and processing a large amount of video and audio data in the conventional digital TV system, it takes a relatively long channel changing time in comparison to the existing analog TV receiver. In other words, since the digital TV receiver wirelessly transmits scanning lines over twice as many as those of the analog TV receiver, the frequency band, i.e., the number of channels, of an HDTV (High Definition Television) is increased several times that of the analog TV receiver, and thus the digital TV system should provide a large number of channels to viewers in comparison to the analog TV receiver. Accordingly, the viewer should individually check a large number of channels when he/she intends to select a desired channel, and it actually requires a lot of time for the viewer to select the channel, thereby causing great inconvenience to the user who cannot obtain channel broadcasting information.

### SUMMARY OF THE INVENTION

Accordingly, the present invention has been made to solve the above-mentioned problems occurring in the prior art, and an object of the present invention is to provide a digital TV system using a high-speed serial bus and a method for controlling the same, which can transmit video and audio data of a TV receiver through a high-speed serial bus and process the data by a processor having a control program so as to implement the digital TV receiver.

Another object of the present invention is to provide a digital TV system using a high-sped serial bus and a method for controlling the same, which can fulfill the consumers' desires for diverse functions of a digital TV receiver by diversely updating and modifying the functions built in the digital TV receiver.

Still another object of the present invention is to provide a digital TV system using a high-speed serial bus and a method for controlling the same, which can process a channel change to a channel through which a digital TV program desired by a user is broadcast more promptly by providing the user with a channel navigation having a list of channel broadcasting programs.

In order to accomplish these objects, there is provided a digital TV system having a computer device connected to a TV receiver through a high-speed serial bus, according to the present invention, wherein the TV receiver comprises a tuner unit for receiving a sky wave, a demodulator for converting the received wave into digital data in the form of a transport stream by checking a digital TV broadcasting signal of the tuner unit, and a high-speed serial bus control unit for transmitting the digital data converted by the demodulator to the computer device through the high-speed serial bus, and wherein the computer device comprises a high-speed serial bus driver for receiving the digital data outputted through the high-speed serial bus control unit of the TV receiver, a central processing unit (CPU) for executing the high-speed serial bus driver, a digital audio/video (AV) process control unit for being executed by the CPU so as to process and display digital video, audio and information data inputted from the high-speed serial bus driver in accordance with a programmed processing means and the information data, and a mass storage device for storing the digital data processed in the high-speed serial bus driver and the digital AV process control unit under the control of the CPU.

The processing means of the digital AV process control unit may includes a demultiplexer for separating the digital data inputted from the high-speed serial bus driver into the video, audio and information data, a video decoder for restoring a TV video signal by using the video and information data from the demultiplexer, an audio decoder for restoring a TV audio signal by using the audio and information data from the demultiplexer, a video renderer for outputting the TV video signal of the video decoder to a TV screen through a video card of the computer device, and an audio renderer for outputting the TV audio signal of the audio decoder through a sound card of the computer device.

The digital TV system may further includes an analog TV broadcasting signal processing unit for digital-processing an analog TV broadcasting video/audio signal.

According to another aspect of the present invention, there is provided a digital TV system using a high-speed serial bus in a digital TV receiver having a digital TV function setting unit, which has a built-in program module for various kinds of functions including a playback and is executed by a digital TV processor, and a memory unit, the digital TV system including a high-speed serial bus control unit for providing an interface for an external control of the digital TV processor and a function setting, a high-speed serial bus driver for providing an interface with the high-speed serial bus control unit through a high-speed serial bus cable, a function control unit for executing an updating and modification process of the program module built in the function setting unit through the high-speed serial bus control unit, the high-speed serial bus driver, and the digital TV processor, a control logic unit having a reservation updating unit and a logic changing unit as an updating and modification process control logic for the execution of the function control unit, a reservation management unit for operating the control logic unit for performing the updating according to reservation setting contents, and an Internet connection unit for connecting to a corresponding server through an Internet under the control of the function control unit when such connection is required for the execution of the control logic unit.

The control logic unit may further include a video transmission unit for receiving and storing a video signal from an external video appliance, selecting a required file, and performing a resolution change and compression of the selected video signal to transmit the compressed video signal to the digital TV receiver.

According to still another aspect of the present invention, there is provided a method for controlling a digital TV system using a high-speed serial bus, which includes the steps of a) a digital TV processor checking a connection of a control device to a digital TV receiver through a high-speed serial bus control unit, and waiting for reception of a control command from the control device, b) the control device initializing a high-speed serial bus driver and preparing a control of the digital TV receiver, c) inputting a control command through an input unit, d) a function control unit of the control device transmitting a control command signal to the digital TV receiver so that a control logic unit selects and performs a process corresponding to the control command, and e) the digital TV receiver performing a function according to the control command signal transmitted from the control device.

In step d), the control command signal includes a control command for transmitting a video signal inputted from an external video appliance according to a process of a video transmission unit, a control command for performing a firmware updating and EPG (Electronic Program Guide) updating of the digital TV receiver according to processes of a reservation management unit and a reservation updating unit, and a control command for performing a function modification of the digital TV receiver according to processes of the reservation management unit and a logic changing unit.

According to still another aspect of the present invention, there is provided a digital TV system using a high-speed serial bus, which includes a TV receiver for receiving broadcasting data, a control device, connected to the TV receiver through the high-speed serial bus, for controlling video and audio signals outputted through the TV receiver, and a channel navigation system for creating a diagrammed EPG (Electronic Program Guide) by processing an EPG included in the broadcasting data, and displaying the processed EPG on the TV receiver.

The channel navigation system may include an EPG extraction unit for extracting the EPG from additional data included in the broadcasting data, a diagrammed EPG processing unit for diagramming the extracted EPG, a channel navigator for displaying the diagrammed EPG on a screen, and a channel selection unit for activating one of displayed channels.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the entire construction of a digital TV system by a computer device connected through a high-speed serial bus according to a first embodiment of the present invention;

FIG. 2 is a block diagram illustrating the entire construction of a digital TV system by a computer device connected through a high-speed serial bus according to a second embodiment of the present invention;

FIG. 3 is a flowchart explaining the operation of a digital TV system by a computer device connected through a high-speed serial bus according to the first and second embodiments of the present invention;

FIG. 4 is a block diagram illustrating the entire construction of an external control device for a function updating for a digital TV receiver using a high-speed serial bus according to a third embodiment of the present invention;

FIG. 5 is a block diagram illustrating the detailed construction of a control logic unit of FIG. 4;

FIG. 6 is a flowchart explaining the operation of an external control device for a function updating for a digital TV receiver according to a third embodiment of the present invention;

FIG. 7 is a flowchart explaining in detail the operation in step S25 of FIG. 6;

FIG. 8 is a flowchart explaining in detail the operation in step S27 of FIG. 6; and

FIG. 9 is a block diagram illustrating the construction of a channel navigation system according to an embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

A digital TV system using a high-speed serial bus according to embodiments of the present invention will now be explained in detail with reference to the accompanying drawings.

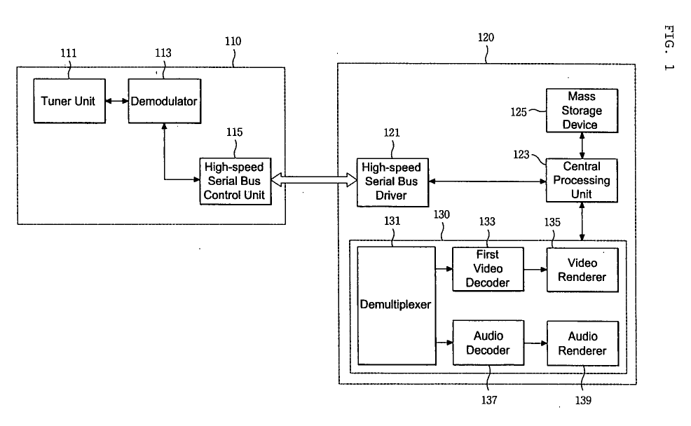

FIG. 1 is a block diagram illustrating the entire construction of a digital TV system by a computer device connected through a high-speed serial bus according to a first embodiment of the present invention.

Referring to FIG. 1, the digital TV system by a computer system connected through a high-speed serial bus according to the first embodiment of the present invention includes a TV receiver 110, and a computer device 120 connected to the TV receiver 110 through a high-speed serial bus.

The high-speed serial bus may be a universal serial bus, or an IEEE1394 bus.

The TV receiver 110 includes a tuner unit 111, a demodulator 113, and a high-speed serial bus control unit 115.

The tuner unit 111 receives a sky wave through an antenna of the TV receiver 110.

The demodulator 113 checks a digital TV broadcasting signal from the tuner unit 111, and converts it into digital data in the form of a transport stream.

The transport stream has a data structure packaged and multiplexed according to the standard.

The high-speed serial bus control unit 115 has a built-in microprocessor for transmitting data at high speed, and transmits digital data converted by the demodulator 113 to the computer device 120 through the high-speed serial bus.

The computer device 120 includes a high-speed serial bus driver 121, a control processing unit (CPU) 123, and a mass storage device 125.

A terminal of a high-speed serial bus cable is connected to the high-speed serial bus control unit 115 of the TV receiver 110, and a port of the high-speed serial bus cable is connected to the high-speed serial bus driver 121 of the computer device 120.

The high-speed serial bus driver 121 receives digital data, i.e., digital video data, audio data, and information data, outputted through the high-speed serial bus control unit 115 of the TV receiver 110 according to a control signal of the CPU 1

A digital AV (Audio/Video) process control unit 130 is executed by the CPU 123 so as to process the digital video, audio and information data inputted from the high-speed serial bus driver according to a control-programmed processing means and the information data and to display the processed video and audio data.

The mass storage device 125 may be an HDD (Hard Disk Drive), and stores the digital data processed through the high-speed serial bus driver 121 and the digital AV process control unit 130, under the control of the CPU 123.

The processing means of the digital AV process control unit 130 includes a demultiplexer 131, a first video decoder 133, a video renderer 135, an audio decoder 137, and an audio renderer 139.

The demultiplexer 131 separates the digital data inputted from the high-speed serial bus driver 121 into video data, audio data, and information data.

The first video decoder 133 restores a TV video signal by using the video and information data from the demultiplexer 131.

The video renderer 135 outputs the TV video signal from the first video decoder 133 to a TV screen through a video card of the computer device 120.

The audio decoder 137 restores a TV audio signal by using the audio and information data from the demultiplexer 131.

The audio renderer 139 outputs the TV audio signal from the audio decoder 137 through a sound card of the computer device 120.

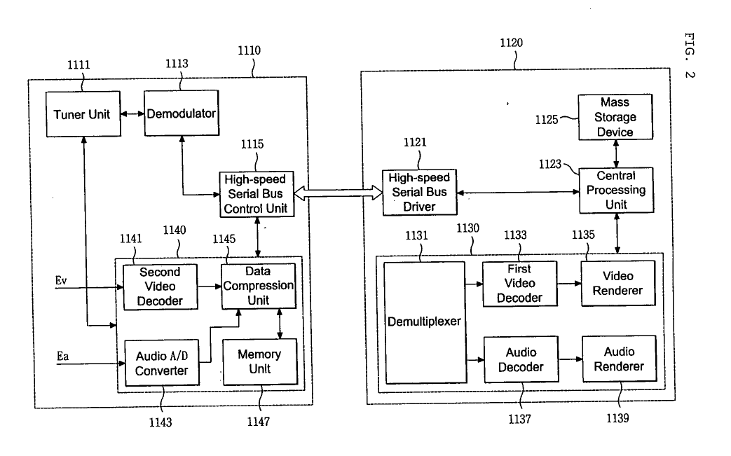

FIG. 2 is a block diagram illustrating the entire construction of a digital TV system by a computer device connected through a high-speed serial bus according to a second embodiment of the present invention.

In comparison to the first embodiment of the present invention, the digital TV system according to the second embodiment of the present invention has the same construction as that according to the first embodiment, except that the TV receiver 1110 additionally has an analog TV broadcasting signal processing unit 1140 for digital-processing analog TV broadcasting video/audio signals, and thus the detailed explanation of the construction except for the analog TV broadcasting signal processing unit 1140 will be omitted.

The analog TV broadcasting signal processing unit 1140 includes a second video decoder 1141, an audio A/D (Analog to Digital) converter 1143, a data compression unit 1145, and a memory unit 1147.

The second video decoder 1141 converts the analog TV broadcasting video signal into digital video data.

The second video decoder 1141 has an external video input terminal Ev, which may be a CVBS (Composite Video Blanking Sync) video terminal or an S-video terminal.

The audio A/D converter 1143 converts the analog TV broadcasting audio signal into digital audio data.

The audio A/D converter 1143 has an external audio input terminal Ea.

The data compression unit 1145 compresses the digital data from the video decoder 1141 and the audio A/D converter 1143 into a format according to the specified standard.

The memory unit 1147 stores temporary data in the compression process performed by the data compression unit 1145.

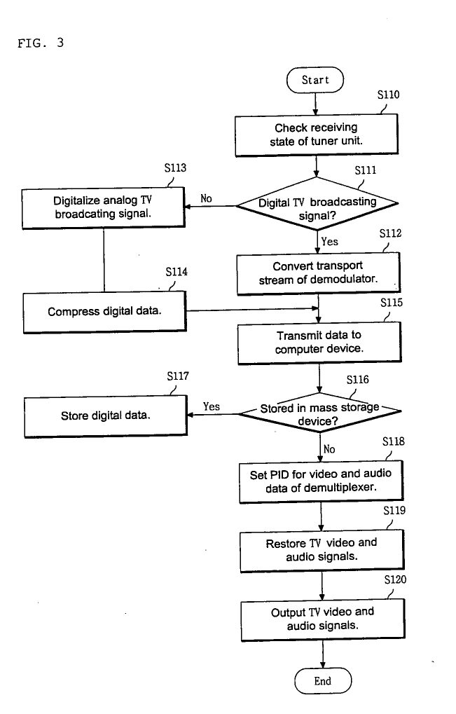

FIG. 3 is a flowchart explaining the operation of a digital TV system by a computer device connected through a high-speed serial bus according to the first and second embodiments of the present invention.

The operation of the digital TV system according to the first and second embodiments of the present invention will be explained with reference to FIG. 3.

The receiving state of the tuner unit 111 or 1111 of the TV receiver 110 or 1110 is checked, and the existence/nonexistence of a digital TV broadcasting signal is judged (S111).

If the digital TV broadcasting signal exists, the demodulator 113 or 1113 converts it into digital data in the form of a transport stream (S112), while if the digital TV broadcasting signal does not exist, the analog TV broadcasting video/audio signal is digitalized in the analog TV broadcasting signal processing unit 1140. Specifically, the analog TV broadcasting video signal is converted into digital video data according to a set resolution by the video decoder 1141, and the analog TV broadcasting audio signal is converted into digital audio data by the audio A/V converter 1143 (S113). This digital audio data is then compressed into an MPEG1, MPEG2, or MPEG3 form according to a compression mode set by the data compression unit 1145 (S114).

The digital data in steps S12 and S14 is processed by the digital AV process control unit 130 or 1130 that is executed by the CPU 123 or 1123, and then transmitted to the computer device 120 or 1120 through the high-speed serial bus control unit 115 or 1115 and the high-speed serial bus driver 121 or 1121 (S115).

The CPU 123 or 1123 judges whether to store digital data in the mass storage device 125 or 1125 (S116), and if the control signal corresponds to “Yes”, it stores the digital data being transmitted in the mass storage device 125 or 1125 (S117).

The demultiplexer 131 or 1131 of the digital AV process control unit 130 or 1130 receives and analyzes the video, audio, and information data, finds a program ID (Program Identifier: PID) of the video and audio data according to the information data, and separates the respective data accordingly (S118). The first video decoder 133 or 1133 and the audio decoder 137 or 1137 decodes the TV video and audio signals according to the set PID to restore the TV video and audio signals (S119).

The video renderer 135 or 1135 and the audio renderer 139 or 1139 output the restored TV video and audio signals through the video card and the sound card, respectively (S120), to terminate the operation.

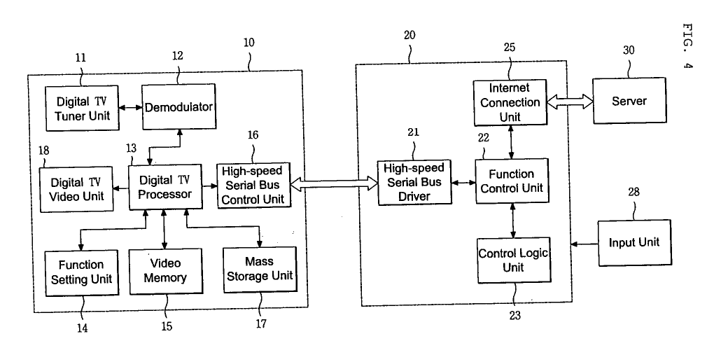

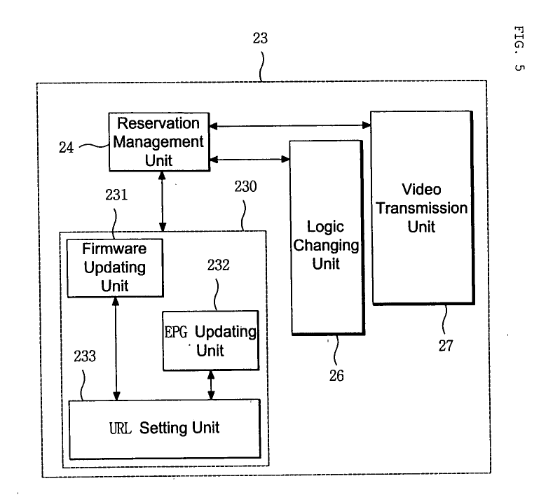

FIG. 4 is a block diagram illustrating the entire construction of an external control device for a function updating for a digital TV receiver using a high-speed serial bus according to a third embodiment of the present invention, and FIG. 5 is block diagram illustrating the detailed construction of the control logic unit 23 of FIG. 4.

Referring to FIGS. 4 and 5, in an external control device for a function updating for a digital TV receiver using a high-speed serial bus according to the third embodiment of the present invention, a control device 20 is connected to a digital TV receiver 10 through a high-speed serial bus.

The high-speed serial bus may be a universal serial bus or an IEEE1394 bus.

The digital TV receiver 10 includes a digital TV tuner unit 11, a demodulator 12, a digital TV processor 13, a function setting unit 14, a video memory 15, a high-speed serial bus control unit 16, a mass storage device 17, and a digital TV video memory 18.

The digital TV tuner unit selects a sky wave received through an antenna, and outputs it to the demodulator 12 through its IF (Intermediate Frequency) pin. The demodulator 12 converts the analog signal from the digital TV tuner unit 11 into digital data in the form of a transport stream, and the digital TV processor 13 restores the digital data to the video signal. The digital TV processor 13 is composed of a plurality of IC chips, and the function setting unit 14 has a built-in program module for various kinds of functions such as playback, recording, and others. Specifically, according to the digital TV receiver according to the present invention, manipulation buttons and a remote controller for key manipulation are connected to the digital TV processor 13 and the function setting unit 14 through their interfaces, and the functions such as playback, recording, and others, are performed by the digital TV processor 13 according to the key manipulation of the corresponding manipulation buttons or remote controller.

The video memory 15 stores video signals received from the control device 20.

The video signals stored in the video memory 15 are displayed in order through the digital TV video memory 18 or an OSD (On Screen Display).

The mass storage device 17 may be an HDD, and stores large-capacity video files transmitted from the control device 20.

The control device 20 includes a high-speed serial bus driver 21, a function control unit 22, a control logic unit 23, a reservation management unit 24, and an Internet connection unit 25.

The high-speed serial bus control unit 16 and the high-speed serial bus driver 21 provide interfaces so that the digital TV receiver 10 and the control device 20 connect to each other through a high-speed serial bus cable, and make it possible to update and modify functions of the digital TV receiver 10 from an outside through the control device 20.

The function control unit 22 updates and modifies the program module built in the function setting unit 14 through the high-speed serial bus control unit 16, the high-speed serial bus driver 21, and the digital TV processor 13.

The control logic unit 23 is the updating and modification process control logic for the execution of the function control unit 22, and is provided with the reservation updating unit 230 and the logic changing unit 26.

The reservation management unit 24 operates the control logic unit 23 in order to perform the updating according to the contents of the reservation setting.

The Internet connection unit 25 serves to connect to a corresponding server 30 through the Internet under the control of the function control unit 22 if it is required for the execution of the control logic unit 23.

The reservation updating unit 230 includes a firmware updating unit 231, an EPG (Electronic Program Guide) updating unit 232, and an URL (Uniform Resource Locator) setting unit 233.

The firmware updating unit 231 updates firmware of the function setting unit 14.

The EPG updating unit 232 updates the contents of EPG.

The URL setting unit 233 sets an Internet URL for the firmware updating unit 231 and the EPG updating unit 232.

The logic changing unit 26 changes and modifies the control logic of the control logic unit 23 to the contents inputted according to the basic user interface, such as a channel change, volume adjustment, picture-quality adjustment, and others.

The control logic unit 23 may further includes a video transmission unit 27. This video transmission unit 27 receives and stores a video signal from an external video appliance, selects a required file, and performs a resolution change and compression of the selected video signal to transmit the compressed video signal to the digital TV receiver.

An input unit 28 is connected to the control device 20 through an interface (not illustrated) provided in the control device 20, and may be manipulation buttons and a remote controller for key manipulation.

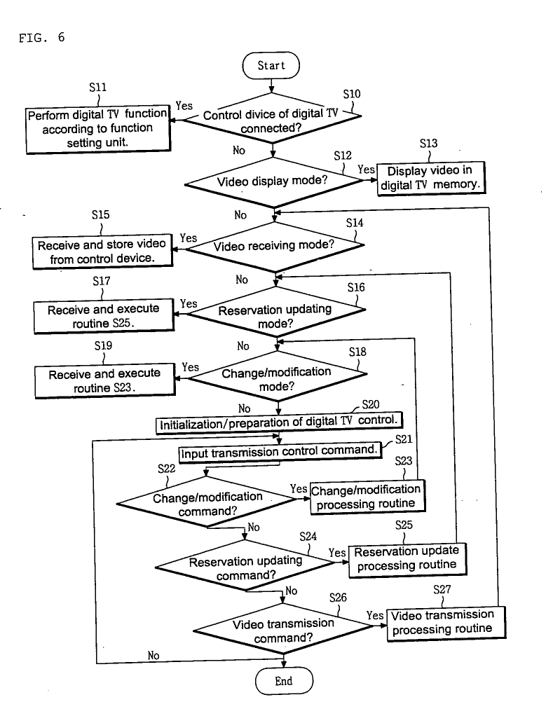

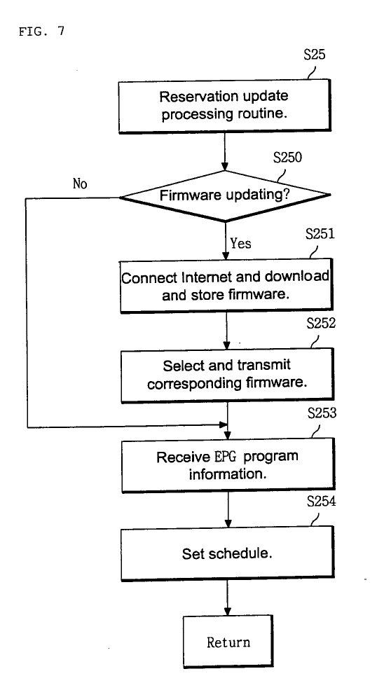

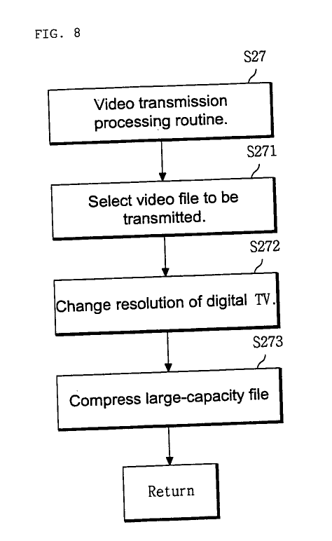

FIG. 6 is a flowchart explaining the operation of an external control device for a function updating for a digital TV receiver according to a third embodiment of the present invention. FIG. 7 is a flowchart explaining in detail the operation in step S25 of FIG. 6, and FIG. 8 is a flowchart explaining in detail the operation in step S27 of FIG. 6.

Referring to FIGS. 6 to 8, the digital TV control method using a high-speed serial bus according to the third embodiment of the present invention will be explained.

The digital TV processor 13 of the digital TV receiver 10 checks the high-speed serial bus control unit 16 (S10), and if the high-speed serial bus driver 21 of the control device 20 is not connected to the digital TV receiver, it performs various functions of the digital TV receiver according to the function setting unit 14 of the digital TV receiver 10, i.e., according to the key input through the manipulation buttons or remote controller (S11).

By contrast, if the high-speed serial bus driver 21 of the control device 20 is connected to the digital TV receiver 10, this means that the digital TV receiver 10 is waiting for the reception of a control command from the control device 20, and in this case, the digital TV processor checks whether the present mode is a video display mode (S12). If it is checked that the present mode is the video display mode in step S12, the digital TV receiver 10 reads the video signal stored in the video memory 15 of the digital TV receiver, and displays the corresponding videos in order through the digital TV video memory 18 or the OSD (S13).

If the present mode is not the video display mode in step S12, the digital TV receiver 10 checks whether the present mode is a video receiving mode (S14). If the present mode is the video receiving mode in step S14, the digital TV receiver 10 receives and stores the video signal in the video memory 15 by executing a video transmission processing routine through the control device 20 (S15).

If the present mode is not the video receiving mode in step S14, the digital TV receiver 10 checks whether the present mode is a reservation updating mode (S16), and performs a corresponding function by executing a reservation update processing routine through the control device 20 (S17).

If the present mode is not the reservation updating mode in step S16, the digital TV receiver 10 checks whether the present mode is a change/modification mode (S18). If so, the digital TV receiver receives the firmware according to the execution of the change/modification processing routine through the control device 20 and changes the function program built in the function setting unit 14 of the digital TV receiver 10, or receives the EPG and registers a reservation schedule of the digital TV 10 receiver (S19).

The control device 20, which is connected to the digital TV receiver 10, initializes the port of the high-speed serial bus driver 21, and prepares the control of the digital TV receiver 10.

If a transmission control command is inputted through the input unit 28 (S21), the digital TV receiver 10 judges whether the input transmission control command is a change/modification control command (S22), and if so, it executes a change/modification processing routine (S23).

If the transmission control command is not the change/modification control command in step S22, the digital TV receiver 10 judges whether the input transmission control command is a reservation update control command (S24), and if so, it executes a reservation update processing routine (S25).

If the transmission control command is not the reservation update control command in step S24, the digital TV receiver 10 judges whether the transmission control command is a video transmission control command (S26), and if so, it executes a video transmission processing routine (S27).

If the transmission control command is not the video transmission control command in step S26, the digital TV receiver terminates its operation or returns to the step S21.

The change/modification processing routine in the step S23 is in the form of a packet in which the contents, such as the channel change, volume adjustment, picture-quality adjustment, and others, which have been inputted according to the basic user interface and processed by the logic changing unit 26, are predetermined, and is transmitted to the function setting unit 14 of the digital TV receiver 10.

If the reservation update processing routine in step S25 refers to the firmware updating according to the reservation update control command (S250), the firmware updating unit 231 accesses the server 30 of an Internet site in which the firmware has been registered through the URL setting unit 233 and the Internet connection unit 25, downloads and stores the firmware (S251).

The firmware updating unit 231 selects and transmits the corresponding firmware to the digital TV receiver 10 to update the function of the function setting unit 14 (S252).

If the reservation update processing routine in step S250 does not refer to the firmware updating in step S250, the EPG updating unit 232 accesses the server 30 of an EPG information providing site through the URL setting unit 233 and the Internet connection unit 25, and receives the corresponding EPG program information (S253). Then, the digital TV receiver sets the schedule of the reservation recording or reservation viewing by transmitting TV program time information and a recording state from the site to the function setting unit 14 of the digital TV receiver 10 (S254), and then returns to step S14.

The video transmission processing routine in step S27 selects the video file to be transmitted to the digital TV receiver 10 (S271), and converts the selected video file into a video file having a resolution enough to be displayed on the digital TV receiver 10 (S272). If the selected file is massive, the video transmission processing routine compresses and transmits the file to the digital TV receiver 10 through the video transmission unit 27, and returns to step S14.

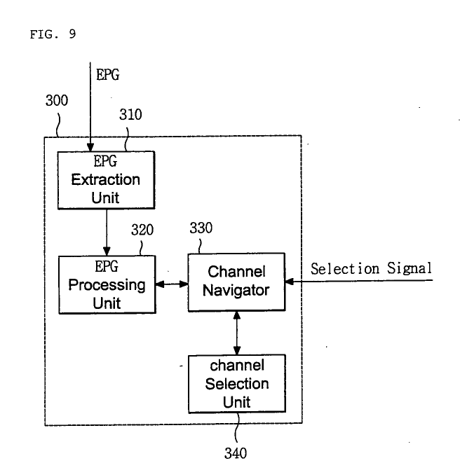

On the other hand, a channel navigation system as illustrated in FIG. 9 may be applied to the digital YV system using the high-speed serial bus according to the first to third embodiments of the present invention. Specifically, the channel navigation system 300 according to the present invention includes an EPG extraction unit 310 for extracting an EPG included in the digital data received through the tuner unit, an EPG processing unit 320 for diagrammatizing the extracted EPG and providing a channel navigator 330 to a viewer, and a channel selection unit 340 for selecting one of channels being displayed by the channel navigator 330 according to the selection signal designated by the viewer. This channel navigation system may be implemented by a separate button allocated among the manipulation buttons or provided in the remote controller, and is activated by the viewer's button manipulation.

The EPG extraction unit 310 extracts the EPG from additional data included in the received digital data. This EPG is a kind of broadcast notification for notifying the kind, time, and size of broadcasting programs.

The EPG processing unit 320 diagrammatizes the EPG extracted by the EPG extraction unit 310 to match the user's preference. Specifically, the EPG processing unit adaptively processes the EPG by arranging the broadcasting programs according to the viewer's preference or the capacities of the programs. For example, if the viewer prefers to data related to current-affair news or economic news, the EPG processing unit 320 may diagrammatize the EPG in the order of local economy and current affairs, national economy and current affairs, world economy and current affairs, and so on, and then provide designated categories to the viewer. Here, category names may be designated by the viewer.

The channel navigator 330 corresponds to a display screen for displaying the EPG processed by the EPG processing unit 320. The channel navigator may be displayed on the entire or a part of the display screen, overlapping the video that is displayed on the screen. The channel navigator 330 arranges the processed EPGs on the screen in the order of their processes, and displays the EPGs as text, still image or simple moving image.

The channel selection unit 340 changes the channel using the CPU in the first and second embodiments of the present invention and the digital TV processor in the third embodiment of the present invention in accordance with the selection signal provided through the viewer's manipulation of the button or remote controller. The EPG information collected by the tuner unit is provided to the computer device or the control device using the high-speed serial bus, and the computer device or the control device processes and displays the EPG information on the TV receiver or the digital TV receiver using the high-speed serial bus, so that the processed EPG can be provided to the viewer.

As described above, according to the digital TV system using the high-speed serial bus according to the embodiments of the present invention, the video and audio data of the TV receiver is transmitted through the high-speed serial bus and processed by the programmed processing means to implement the digital TV receiver, so that any separate PCI or ISA type computer card is not required.

In addition, the consumers' desires for diverse functions of a digital TV receiver can be fulfilled by diversely updating and modifying the functions built in the digital TV receiver.

Last, a channel change to a channel through which a digital TV program desired by a user is broadcast can be made more promptly by providing the user with the channel navigation having diagrammatized channel broadcasting programs.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A digital TV system having a computer device connected to a TV receiver through a high-speed serial bus;
wherein the TV receiver comprises:
a tuner unit for receiving a sky wave;
a demodulator for converting the received wave into digital data in the form of a transport stream by checking a digital TV broadcasting signal of the tuner unit; and
a high-speed serial bus control unit for transmitting the digital data converted by the demodulator to the computer device through the high-speed serial bus; and
wherein the computer device comprises:
a high-speed serial bus driver for receiving the digital data outputted through the high-speed serial bus control unit of the TV receiver;
a central processing unit (CPU) for executing the high-speed serial bus driver;
a digital audio/video (AV) process control unit for being executed by the CPU so as to process and display digital video, audio and information data inputted from the high-speed serial bus driver in accordance with a programmed processing means and the information data; and
a mass storage device for storing the digital data processed in the high-speed serial bus driver and the digital AV process control unit under the control of the CPU.

2. The digital TV system as claimed in claim 1, further comprising an analog TV broadcasting signal processing unit for digital-processing an analog TV broadcasting audio/video (AV) signal.

3. The digital TV system as claimed in claim 2, wherein the analog TV broadcasting signal processing unit comprises:
a video decoder for converting the analog TV broadcasting video signal into digital video data;
an audio analog to digital (A/D) converter for converting the analog TV broadcasting audio signal into digital audio data;
a data compression unit for compressing the digital data from the video decoder and the audio A/D converter into a format according to a specified standard; and
a memory unit for storing temporary data produced in a compression process performed by the data compression unit.

4. The digital TV system as claimed in claim 1, wherein the processing means of the digital AV process control unit comprises:
a demultiplexer for separating the digital data inputted from the high-speed serial bus driver into the video, audio and information data;
a video decoder for restoring a TV video signal by using the video and information data from the demultiplexer;
an audio decoder for restoring a TV audio signal by using the audio and information data from the demultiplexer;
a video renderer for outputting the TV video signal of the video decoder to a TV screen through a video card of the computer device; and
an audio renderer for outputting the TV audio signal of the audio decoder through a sound card of the computer device.

5. The digital TV system as claimed in claim 2, wherein the processing means of the digital AV process control unit comprises:
a demultiplexer for separating the digital data inputted from the high-speed serial bus driver into the video, audio and information data;
a video decoder for restoring a TV video signal by using the video and information data from the demultiplexer;
an audio decoder for restoring a TV audio signal by using the audio and information data from the demultiplexer;
a video renderer for outputting the TV video signal of the video decoder to a TV screen through a video card of the computer device; and
an audio renderer for outputting the TV audio signal of the audio decoder through a sound card of the computer device.

6. The digital TV system as claimed in claim 1, wherein the high-speed serial bus is a universal serial bus.

7. The digital TV system as claimed in claim 1, wherein the high-speed serial bus is an IEEE1394 bus.

8. A digital TV system using a high-speed serial bus in a digital TV receiver having a digital TV function setting unit, which has a built-in program module for various kinds of functions including a playback and is executed by a digital TV processor, and a memory unit, the digital TV system comprising:
a high-speed serial bus control unit for providing an interface for an external control of the digital TV processor and a function setting;
a high-speed serial bus driver for providing an interface with the high-speed serial bus control unit through a high-speed serial bus cable;
a function control unit for executing an updating and modification process of the program module built in the function setting unit through the high-speed serial bus control unit, the high-speed serial bus driver, and the digital TV processor;
a control logic unit having a reservation updating unit and a logic changing unit as an updating and modification process control logic for the execution of the function control unit;
a reservation management unit for operating the control logic unit for performing the updating according to reservation setting contents; and
an Internet connection unit for connecting to a corresponding server through an Internet under the control of the function control unit when such connection is required for the execution of the control logic unit.

9. The digital TV system as claimed in claim 8, wherein the reservation updating unit comprises:
a firmware updating unit for updating firmware of the function setting unit;
an EPG (Electronic Program Guide) updating unit for updating contents of an EPG; and
an URL (Uniform Resource Locator) setting unit for setting an Internet URL for the firmware updating unit and the EPG updating unit.

10. The digital TV system as claimed in claim 8, wherein the control logic unit further comprises a video transmission unit for receiving and storing a video signal from an external video appliance, selecting a required file, and performing a resolution change and compression of the selected video signal to transmit the compressed video signal to the digital TV receiver.

11. A method for controlling a digital TV system using a high-speed serial bus, the method comprising the steps of:
a) a digital TV processor checking a connection of a control device to a digital TV receiver through a high-speed serial bus control unit, and waiting for reception of a control command from the control device;
b) the control device initializing a high-speed serial bus driver and preparing a control of the digital TV receiver;
c) inputting a control command through an input unit;
d) a function control unit of the control device transmitting a control command signal to the digital TV receiver so that a control logic unit selects and performs a process corresponding to the control command; and
e) the digital TV receiver performing a function according to the control command signal transmitted from the control device.

12. The method as claimed in claim 11, wherein in step d), the control command signal includes a control command for transmitting a video signal inputted from an external video appliance according to a process of a video transmission unit.

13. The method as claimed in claim 11, wherein in step d), the control command signal includes a control command for performing a firmware updating and EPG (Electronic Program Guide) updating of the digital TV receiver according to processes of a reservation management unit and a reservation updating unit.

14. The method as claimed in claim 11, wherein in step d), the control command signal includes a control command for performing a function modification of the digital TV receiver according to processes of a reservation management unit and a logic changing unit.

15. A digital TV system using a high-speed serial bus, comprising:
a TV receiver for receiving broadcasting data;
a control device, connected to the TV receiver through the high-speed serial bus, for controlling video and audio signals outputted through the TV receiver; and
a channel navigation system for creating a diagrammed EPG (Electronic Program Guide) by processing an EPG included in the broadcasting data, and displaying the processed EPG on the TV receiver.

16. The digital TV system as claimed in claim 15, wherein the channel navigation system comprises:
an EPG extraction unit for extracting the EPG from additional data included in the broadcasting data;
a diagrammed electronic program guide processing unit for diagramming the extracted EPG;
a channel navigator for displaying the diagrammed EPG on a screen; and
a channel selection unit for activating one of displayed channels.

17. The digital TV system as claimed in claim 15, wherein the TV receiver comprises:
a tuner unit for receiving a sky wave;
a demodulator for converting the received wave into digital data in the form of a transport stream by checking a digital TV broadcasting signal of the tuner unit; and
a high-speed serial bus control unit for transmitting the digital data converted by the demodulator to the computer device through the high-speed serial bus; and
wherein the control device comprises:
a high-speed serial bus driver for receiving the digital data outputted through the high-speed serial bus control unit of the TV receiver;
a central processing unit (CPU) for executing the high-speed serial bus driver;
a digital audio/video (AV) process control unit for being executed by the CPU so as to process and display digital video, audio and information data inputted from the high-speed serial bus driver in accordance with a programmed processing means and the information data; and
a mass storage device for storing the digital data processed in the high-speed serial bus driver and the digital AV process control unit under the control of the CPU.

18. The digital TV system as claimed in claim 17, wherein the TV receiver further comprises an analog TV broadcasting signal processing unit for digital-processing an analog TV broadcasting audio/video (AV) signal; and
wherein the analog TV broadcasting signal processing unit comprises a video decoder for converting the analog TV broadcasting video signal into digital video data, an audio analog to digital (A/D) converter for converting the analog TV broadcasting audio signal into digital audio data, a data compression unit for compressing the digital data from the video decoder and the audio A/D converter into a format according to a specified standard, and a memory unit for storing temporary data produced in a compression process performed by the data compression unit.

19. The digital TV system as claimed in claim 15, wherein the control device comprises:
a digital TV processor having a built-in program module for various kinds of functions including a playback;
a digital TV function setting unit for being executed by the digital TV processor, and a memory unit;
a high-speed serial bus control unit for providing an interface for an external control of the digital TV processor and a function setting;
a high-speed serial bus driver for providing an interface with the high-speed serial bus control unit through a high-speed serial bus cable;
a function control unit for executing an updating and modification process of the program module built in the function setting unit through the high-speed serial bus control unit, the high-speed serial bus driver, and the digital TV processor;
a control logic unit having a reservation updating unit and a logic changing unit as an updating and modification process control logic for the execution of the function control unit;
a reservation management unit for operating the control logic unit for performing the updating according to reservation setting contents; and
an Internet connection unit for connecting to a corresponding server through an Internet under the control of the function control unit when such connection is required for the execution of the control logic unit.

20. The digital TV system as claimed in claim 19, wherein the reservation updating unit comprises:
a firmware updating unit for updating firmware of the function setting unit;
an EPG (Electronic Program Guide) updating unit for updating contents of an EPG; and
an URL (Uniform Resource Locator) setting unit for setting an Internet URL for the firmware updating unit and the EPG updating unit.

21. The digital TV system as claimed in claim 19, wherein the control logic unit further comprises a video transmission unit for receiving and storing a video signal from an external video appliance, selecting a required file, and performing a resolution change and compression of the selected video signal to transmit the compressed video signal to the digital TV receiver.
